(19) United States
(12) Patent Application Publication
(10) Pub. No.: US 2010/0099530 A1
(43) Pub. Date: Apr. 22, 2010

(54) Bicycle Cogset

(76) Inventors: Douglas Chiang, Wufeng Shiang (TW); Chia-Wei Liao, Wufeng Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/642,924

(22) Filed: Dec. 21, 2009

Related U.S. Application Data
(63) Continuation-in-part of application No. 12/057,393, filed on Mar. 28, 2008.

(51) Int. Cl. F16H 55/30; F16H 55/17

(52) U.S. Cl. 474/160; 474/152

(57) ABSTRACT

A cogset, which is adapted to connect to a rotatable hub of a bicycle, includes first, second and third cog assemblies. Each cog assembly has at least one cog with which a chain on the bicycle selectively engages in response to bicycle speed changes. Additionally, the first and third cog assemblies have structural contacts with the connected hub of the bicycle, whereas the second cog assembly does not have any structural contact with the connected hub, but the second cog assembly is retained between the first and third cog assemblies in order to connect it to the hub and enable it rotate with the hub stably.

### CROSS REFERENCE

The present application is a continuation-in-part application of U.S. patent application Ser. No. 12/057,393, filed on Mar. 28, 2008, of which the entire disclosure is incorporated herein.

### BACKGROUND OF THE INVENTION

1. Field of the Invention

The present invention relates to a cogset with improved reliability and repairability, and its components can be easily and securely installed to each other, and more particularly, the cogset has the advantage of being lightweight.

2. Description of the Related Art

U.S. Publication No. 2003/0064844 shows a cogset which is a combination of a plurality of cog assemblies. The cog assemblies are substantially of the same design and each is configured as including a hub for connecting the cog assembly to a hub of a bicycle, and at least one cog extending from the hub. In addition, the hub of each cog assembly includes a groove defined therein. Further, the cog assemblies are connected to one another by utilizing fasteners to insert in the grooves of the associated cog assemblies sequentially. Generally, the modulized cogset would have optimum repairability.

U.S. Pat. No. 6,428,437 shows a cogset including a carrier and a plurality of cogs encapsulated on the carrier. In use, the carrier is engaged on a hub of a bicycle to connect the plurality of cogs to the hub. As set forth in the description, driving torque is applied to the cogs and transmitted to the hub, thus it is an object of the invention that the carrier increases its engagement surface area with respect to the hub, thereby allowing the carrier to be made of lower strength material or lightweight metal.

In spite of the advantages that the cogset has by employing a carrier which enable it to connect to a hub of the bicycle or designed according to a modulization concept, it is still desired to make improvements to a cogset in order to make it lightweight, reliable, and more repairable.

The present invention is, therefore, intended to obviate or at least alleviate the problems encountered in the prior art.

### SUMMARY OF THE INVENTION

According to the present invention, a cogset, which is adapted to connect to a rotatable hub, includes first, second and third cog assemblies. The first cog assembly includes a plurality of first cogs and a carrying member on which each first cog is mounted. Each first cog includes a first hole which extends therethrough and is inserted through by the hub after the first cog assembly and the hub are engaged with each other. The carrying member includes an orifice which extends therethrough and is inserted through by the hub after the first cog assembly and the hub are engaged with each other. Additionally, the first hole in every first cog has a size such that each first cog is free of a structural contact with the hub, and the orifice has a size such that the carrying member has a structural contact with the hub and is rotatable with the hub. Accordingly, in order to connect each first cog to the hub and enable it to rotate with the hub, each first cog is connected to the carrying member. The second cog assembly includes a plurality of second cogs engaged and being in contact with one another. Each second cog includes a second hole which extends therethrough and is inserted through by the hub after the second cog assembly and the hub are engaged with each other. The second hole in every second cog has a size such that each second cog is free of a structural contact with the hub. Accordingly, in order to connect each second cog to the hub and enable it to rotate with the hub, at least one second cog is utilized to engage with the carrying member to connect the rest of the second cogs to the first cog assembly. The second cog assembly is retained between the first and third cog assemblies in order to enable it rotate with the hub stably.

It is therefore an object of the present invention that the hole in each of the first, second, and third cogs is designed with a diametrical size under consideration of balancing the advantage of being lightweight and the disadvantage of weakened structural strength.

It is another object of the present invention that each second cog of the second cog assembly is formed separately

It is yet another object of the present invention that the second cog assembly includes a plurality of groups of integrally made second cogs.

It is a further object of the present invention that the second cog assembly includes all the second cogs made integrally.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a cogset in accordance with a first embodiment of the present invention.

FIG. 2 is a partial, exploded perspective view of the cogset shown in FIG. 1.

FIG. 3 is an exploded perspective view of the cogset shown in FIG. 1. FIG. 4 is another exploded perspective view of the cogset taken from a different view than that of FIG. 3.

FIG. 5 is a cross-sectional view of a first cog assembly embodying the present invention.

FIG. 6 is another cross-sectional view of the first cog assembly taken along 6-6 of FIG. 5.

FIG. 7 is a cross section view of a second cog assembly embodying the present invention.

FIG. 8 is another cross-sectional view of the second cog assembly taken along line 8-8 of FIG. 7.

FIG. 9 is a cross-sectional view of a third cog assembly embodying the present invention.

FIG. 10 is another cross-sectional view of the third cog assembly taken along line 10-10 of FIG. 9

FIG. 11 is a cross-sectional view showing installation of the cogset of the present invention on a hub of a bicycle.

FIG. 12 is an extended view of FIG. 11 and shows the cogset mounted on the hub.

FIG. 13 is a cross-sectional view of the cogset and the hub taken along line 13-13 of FIG. 12.

FIG. 14 is a cross-sectional view of the cogset and the hub taken along line 14-14 of FIG. 12.

FIG. 15 is a cross-sectional view of the cogset and the hub taken along line 15-15 of FIG. 12.

FIG. 16 is a cross-sectional view of the cogset and the hub taken along line 16-16 of FIG. 12.

FIG. 17 is a cross-sectional view showing a cogset in accordance with a second embodiment of the present invention mounted on a hub of a bicycle.

FIG. 18 is a cross-sectional view showing a cogset in accordance with a third embodiment of the present invention mounted on a hub of a bicycle.

### DETAILED DESCRIPTION OF THE PREFERRED EMBODIMENT

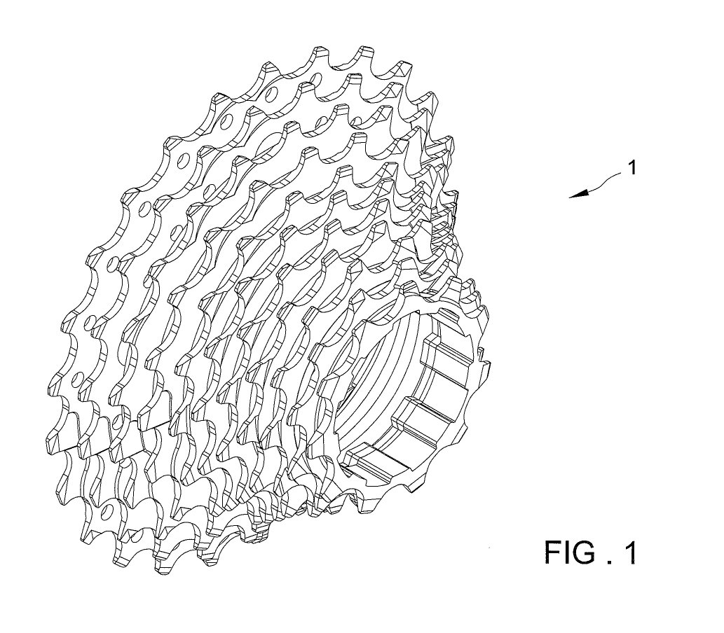

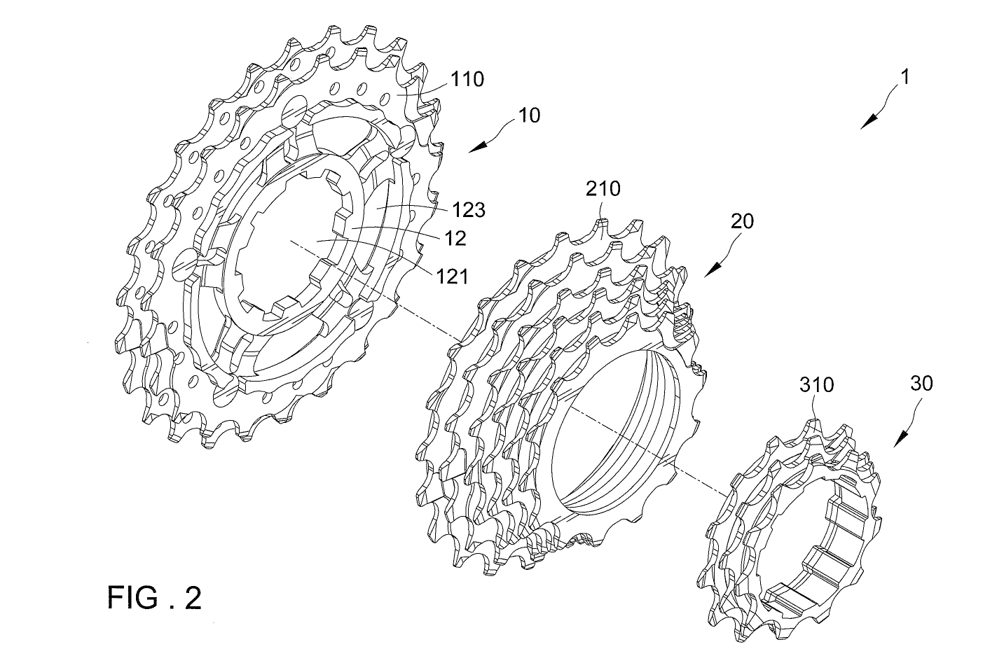

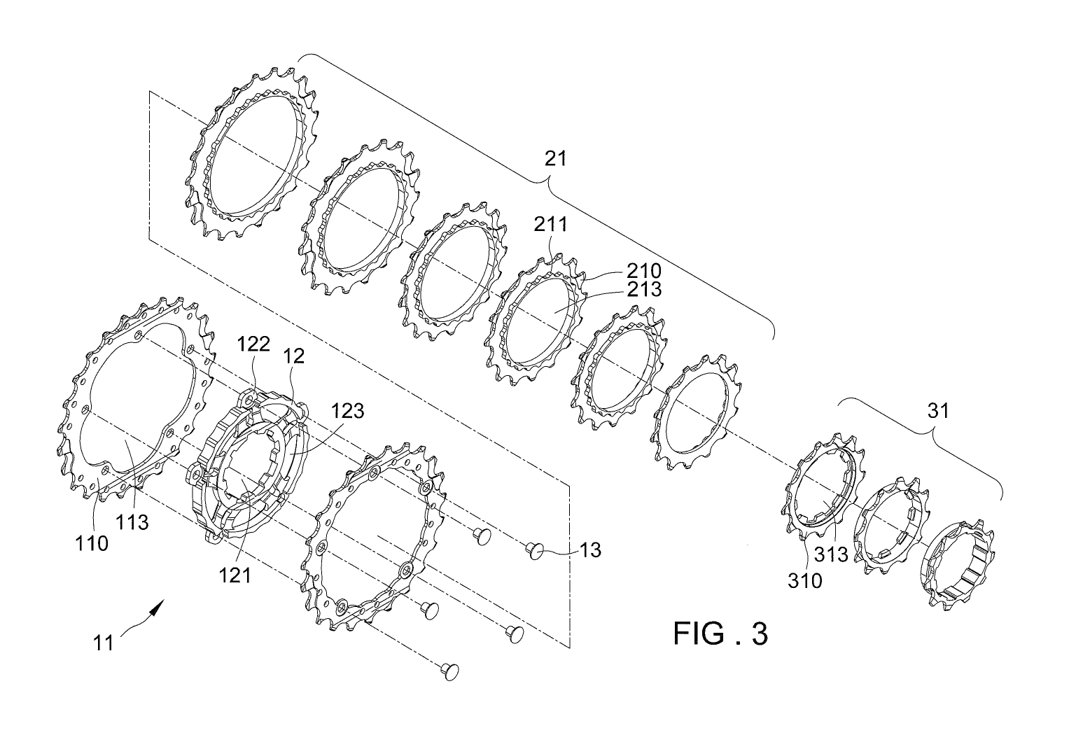

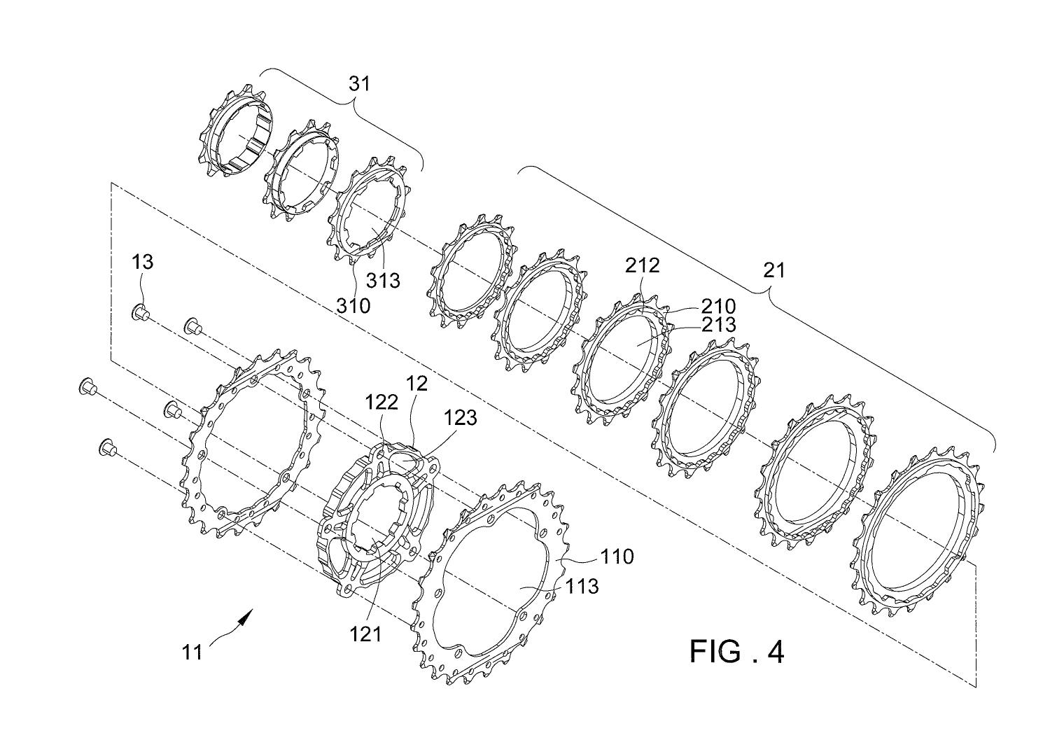

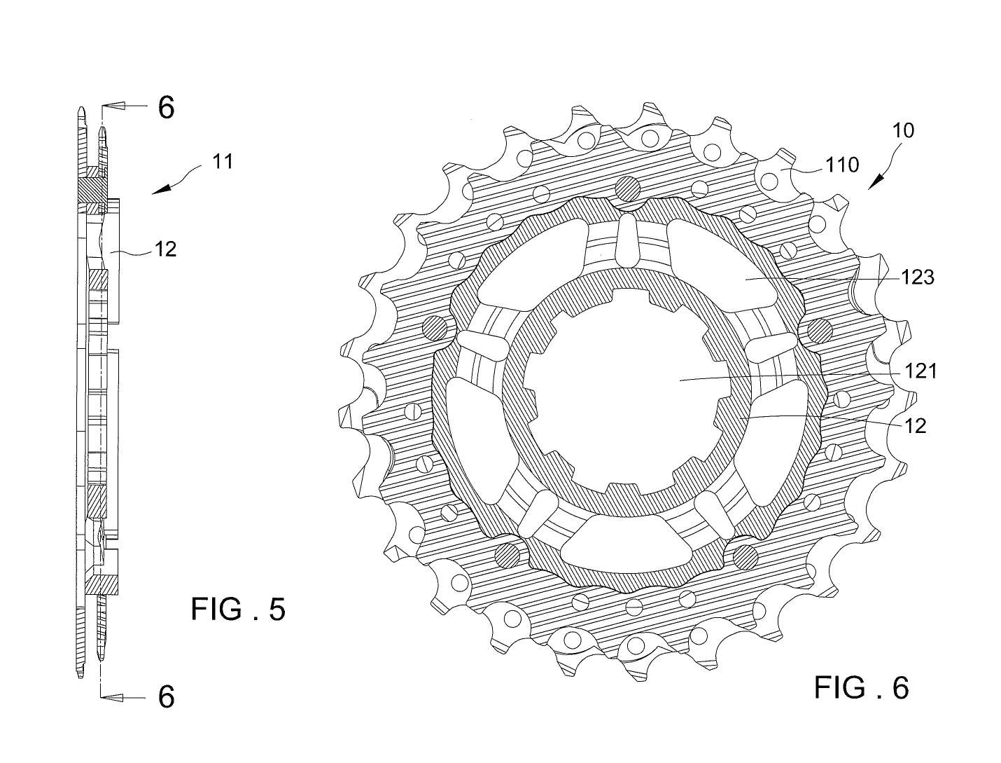

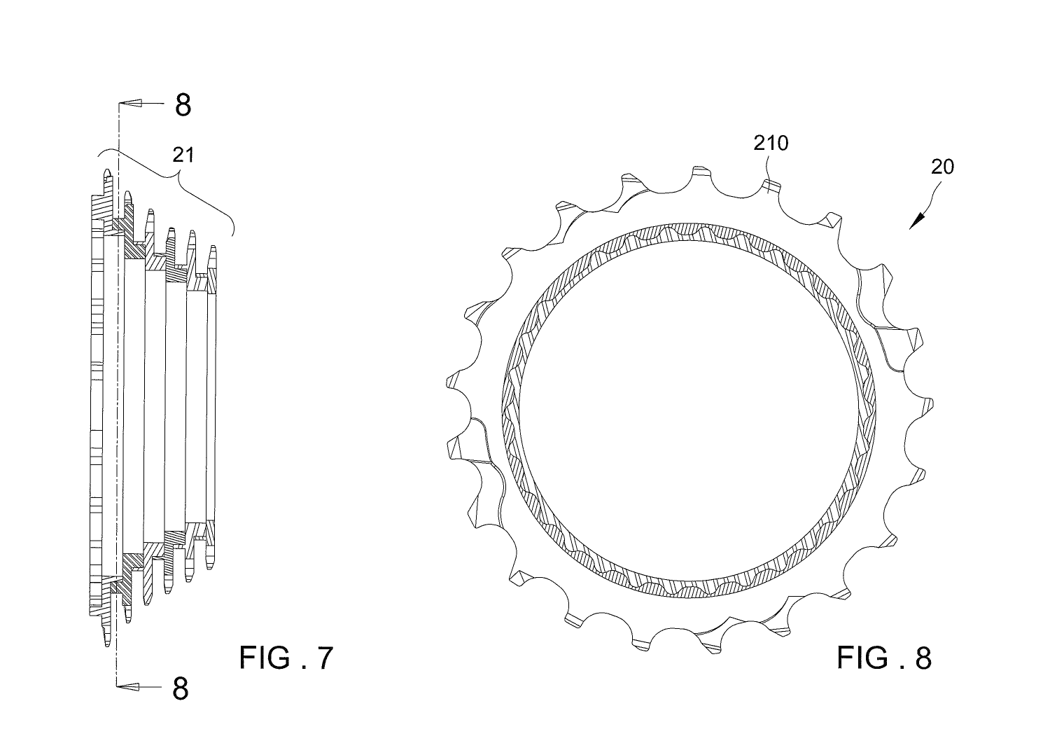

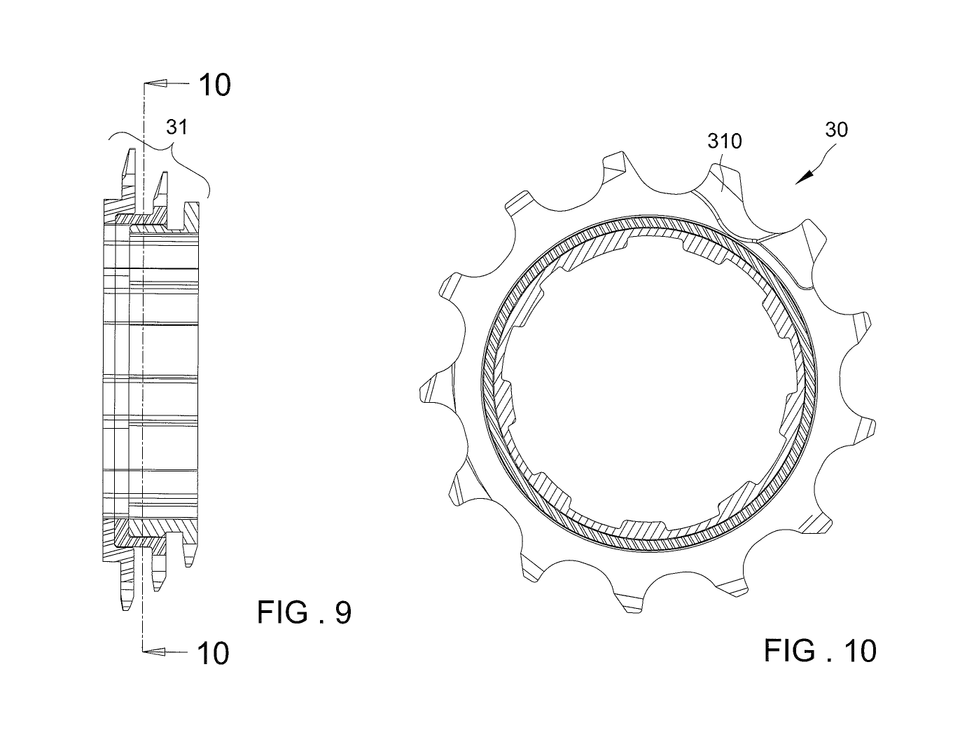

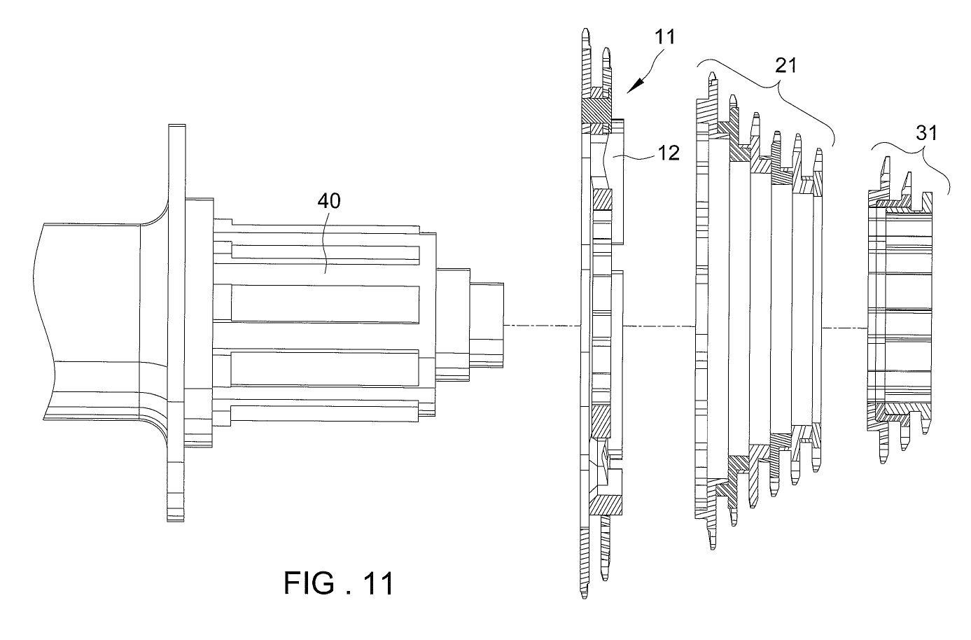

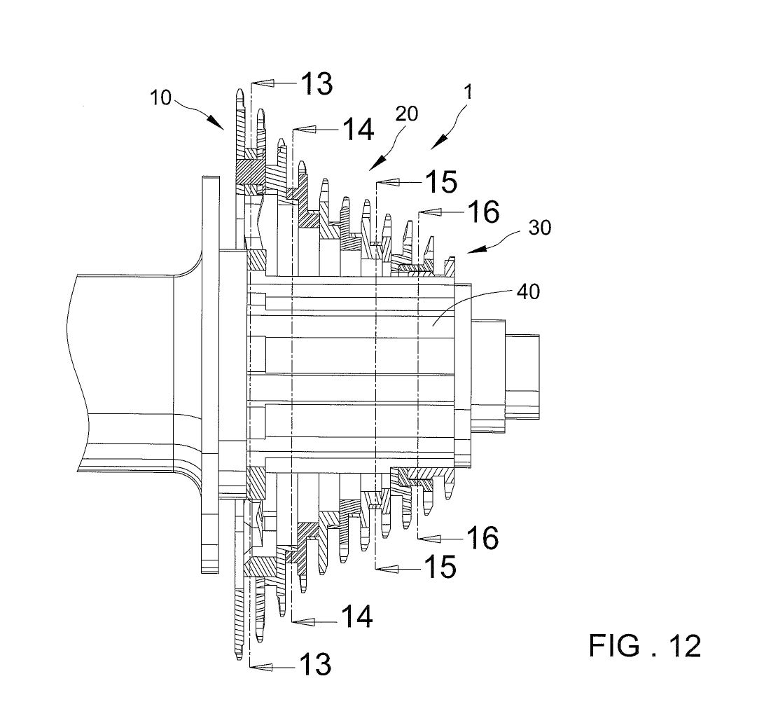

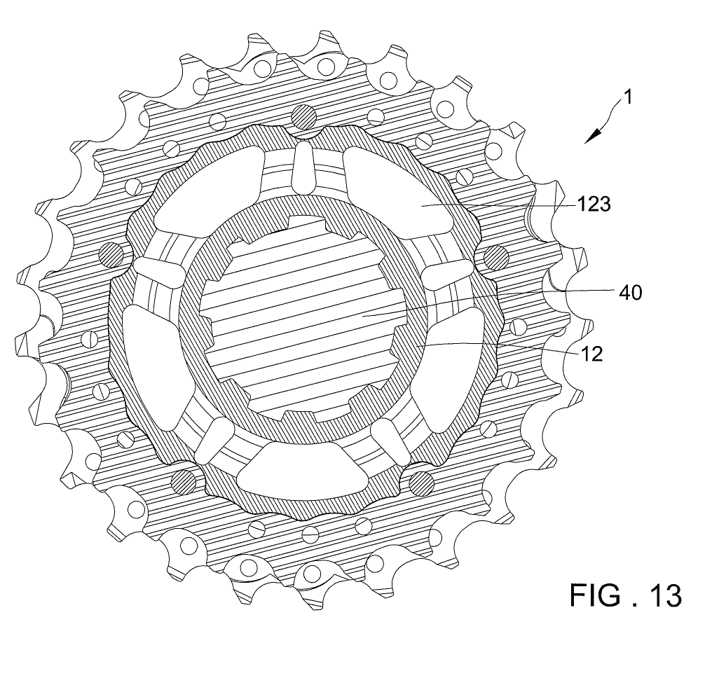

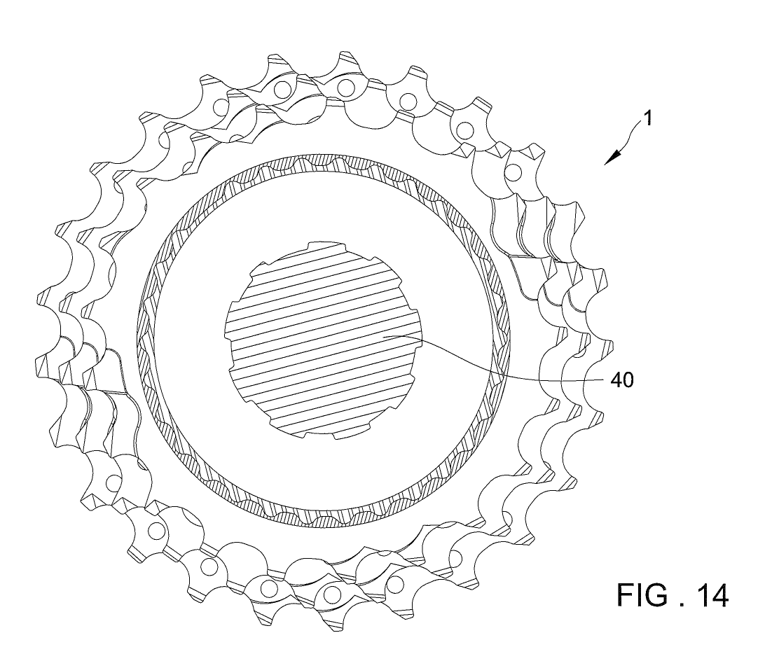

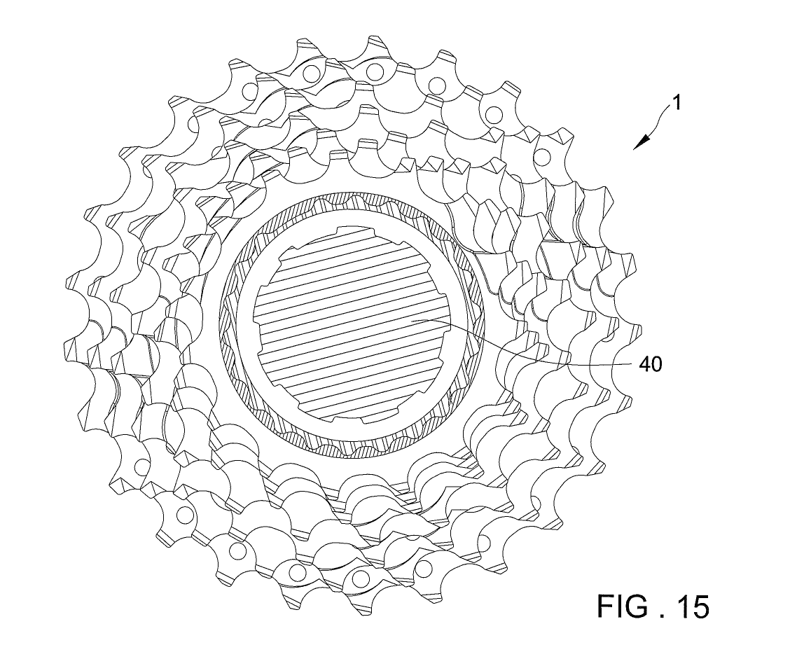

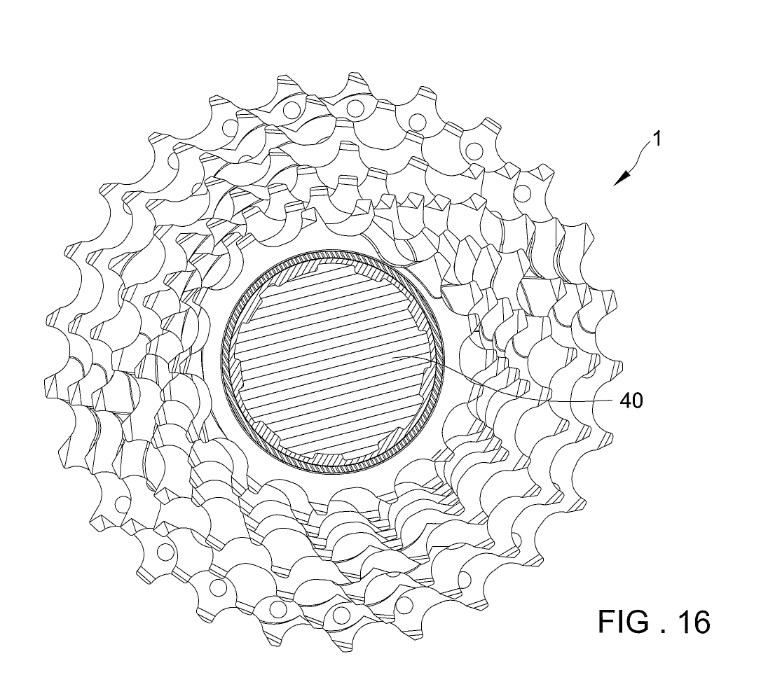

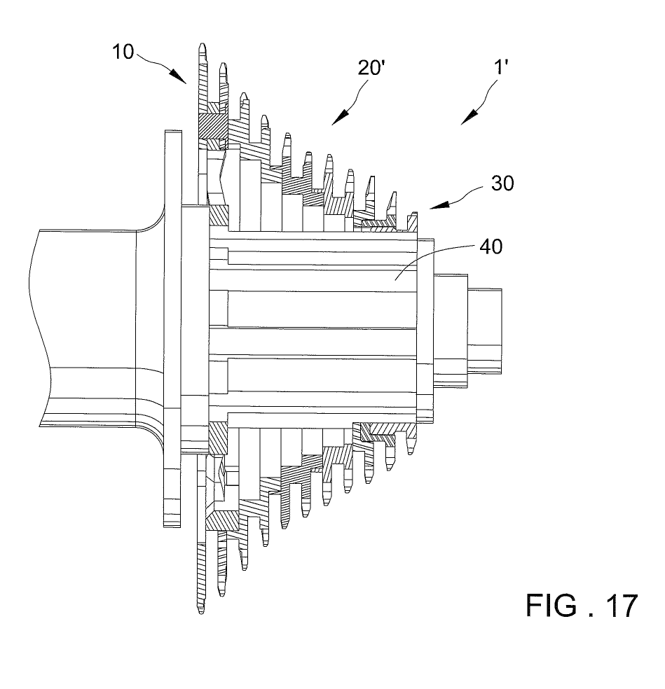

Referring to FIGS. 1 through 16, a cogset 1 in accordance with a first embodiment of the present invention is adapted to connect to a rotatable hub 40 in a bicycle. The cogset 1 includes a first 10, a second 20, and a third 30 cog assemblies. The first cog assembly 10 includes a plurality of first cogs 11 and each first cog 11 is formed separately. The second cog assembly 20 includes a plurality of second cogs 21 and each second cog 21 is formed separately. The third cog assembly 30 includes a plurality of third cogs 31 and each third cog 31 is formed separately. Each of the first 11, second 21, and third 31 cogs is engagable with a chain in the bicycle. Specifically, each of the first 11, second 21, and third 31 cogs includes a plurality of teeth 110, 210 and 310 formed around its outer peripheral edge to cooperate with the chain.

Preferably, the plurality of teeth 110, 210 and 310 in each of the first 11, second 21, and third 31 cogs collectively define a sinuate and enclosed cross section.

In addition, the chain would selectively engage with the first 11, second 21 and third 31 cogs and shift from one to another in response to bicycle speed changes. Moreover, each of the first 11, second 21, and third 31 cogs includes a hole 113, 213 and 313 which extends therethrough and is delimited by its inner peripheral edge. The hole 113, 213 and 313 in each of the first 11, second 21, and third 31 cogs would be inserted through by the hub 40 after the cogset 1 is mounted on the hub 40. Additionally, the hole 113, 213 and 313 in each of the first 11, second 21, and third 31 cogs is designed with a diametrical size under consideration of balancing the advantage of being lightweight and the disadvantage of weakened structural strength. In the embodiment, the hole 113 and 213 in each of the first 11 and second 21 cogs has a size greater than a size of the connected hub 40 so each first 11 and second 21 cog is free of structural contacts with the hub 40, and the hole 313 in each third cog 31 has a size the same as a size of the hub 40 so each third cog 31 has its inner peripheral edge engagable with the outer peripheral edge of the hub 40.

Preferably, each of the first 11, second 21 and third 31 cogs has a radial distance, which is measured from the center of the associated hole 113, 213 and 313 to its outer peripheral edge, differentiates from one another in order to accomplish different bicycle speeds.

Preferably, the radial distance of any first cog 11 is larger than the radial distance of any second cog 21, and the radial distance of any second cog 21 is larger than the radial distance of any third cog 31.

The first cog assembly 10 further includes a carrying member 12 for connecting the plurality of first cogs 11 to the hub 40, since each first cog 11 can not structurally contact with the hub 40 by itself. Additionally, the carrying member 12 is structurally free of the chain of the bicycle. Further, the carrying member 12 includes an orifice 121 which extends therethrough and is delimited by the inner peripheral edge of the carrying member 12. The orifice 121 has a size substantially the same as that of the hub 40 so the inner peripheral edge of the carrying member 12 would contact with the outer peripheral edge of the hub 40 after the carrying member 12 and the hub 40 are engaged with each other. Additionally, the inner peripheral edge of the carrying member 12 has a contour conforming mutually to the outer peripheral edge of the connected hub 40 such that the carrying member 12 is prevented from rotating relative to the hub 40, and the carrying member 12 is rotated with the hub 40 after the hub 40 is rotated.

Preferably, the cross sections of the inner peripheral edge of the carrying member 12 and the outer peripheral edge of the hub 40 are sinuate and enclosed.

In addition, the plurality of first cogs 11 are connected to the carrying member 12 by utilizing a plurality of fasteners 13 to insert through the plurality of first cogs 11 and a plurality of lugs 122 which extend outwardly from the outer peripheral edge of the carrying member 12. However, other means for securing the plurality of first cogs 11 is within the scope of the invention.

Preferably, there are at least two first cogs 11 mounted on the carrying member 12.

Preferably, the carrying member 12 includes a plurality of cutouts 123 extending therethrough for reducing its weight.

The plurality of second cogs 21 of the second cog assembly 20 are engaged and being in contact with one another. In the embodiment, any two second cogs 21 are connected with each other by engaging a plurality of ridges 211 formed on one second cog 21 in a plurality of recesses 212 formed on the other. Additionally, the plurality of ridges 211 collectively define a contour conforming mutually to a contour the plurality of recesses 212 collectively define such that the two connected second cogs 21 are prevented from relative rotation therebetween. Preferably, the cross sections of the plurality of ridges 211 and recesses 212 are sinuate. Moreover, each second cog 21 includes two opposing sides and the plurality of ridges 211 and recesses 212 are formed on the two sides, respectively.

In addition, since each second cog 21 can not structurally contact with the hub 40 by itself, the second cog assembly 20 is connected to the hub 40 by engaging with the first cog assembly 10. In the embodiment, the second cog assembly 20 utilizes one of its second cogs 21 to engage with the carrying member 12 so the rest of connected second cogs 21 can connect to the first cog assembly 10 by fixing to this specific second cog 21. Preferably, the plurality of recesses 211 in this particular second cog 21 collectively receive and conform mutually to the outer peripheral edge of the carrying member 12 such that this second cog 21 and the rest of second cogs 21 connected thereto are prevented from rotating relative to the carrying member 12.

In addition, the plurality of third cogs 31 of the third cog assembly 30 are engaged and being in contact with each other. In the embodiment, any two third cogs 31 are engaged with each other by engaging the inner peripheral edge of one third cog 31 with the outer peripheral edge of the other. Also, each third cog 31 would have its inner peripheral edge engaging with the outer peripheral edge of the connected hub 40 after the third cog assembly 30 is assembled on the hub 40. Additionally, the inner peripheral edge of each third cog 31 has a contour conforming mutually to the outer peripheral edge of the hub 40 such that the third cog 31 is prevented from rotating relative to the hub 40.

Preferably, the cross section of each third cog 31 is sinuate and enclosed.

In addition, the second cog assembly 20 is retained between the first 10 and third 30 cog assemblies in order to enable it rotate with the hub 40 stably.

Referring to FIG. 17, a cogset 1′ in accordance with a second embodiment of the present invention differentiates from the first embodiment in that it includes a second cog assembly 20′. The second cog assembly 20′ is similar to the second cog assembly 20 except that it includes a plurality of groups of integrally made second cogs 21. As illustrated exemplarily, one group includes three integrally made second cogs 21, another group includes two integrally made second cogs 21.

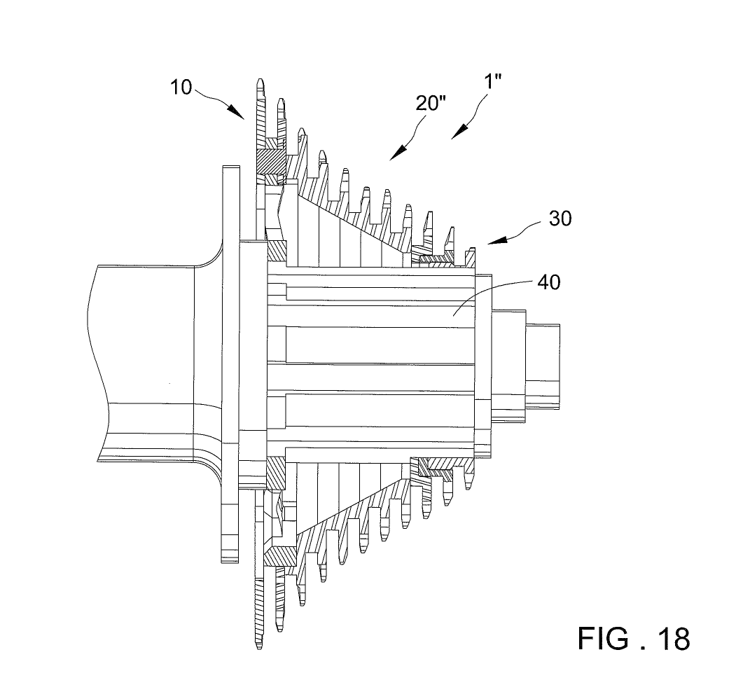

Referring to FIG. 18, a cogset 1″ in accordance with a third embodiment of the present invention differentiates from the first embodiment in that it includes a second cog assembly 20″. The second cog assembly 20″ is similar to the second cog assembly 20 except that it includes all the second cogs 21 made integrally.

While the specific embodiments have been illustrated and described, numerous modifications come to mind without significantly departing from the spirit of invention, and the scope of invention is only limited by the scope of the accompanying claims.

What is claimed is:

1. A cogset which is adapted to connect to a rotatable hub, comprising:
a cog assembly including a carrying member including an orifice which extends therethrough and is inserted through by the hub upon engagement therebetween, and with the orifice having a size such that the carrying member has a structural contact with the hub and is rotatable with the hub;
a second cog assembly including a plurality of second cogs engaged and being in contact with one another, with each second cog including a second hole which extends therethrough, with at least one second cog engaged with the carrying member to connect the rest of the second cogs to the first cog assembly and enable the second cog assembly rotate with the hub when the hub is rotated, with the second hole in every second cog inserted through by the hub, and with the second hole in every second cog having a size such that each second cog is free of a structural contact with the hub.

2. The cogset as claimed in claim 1 further comprising a third cog assembly, with the second cog assembly retained between the first and third cog assemblies in order to enable it rotate with the hub stably.

3. The cogset as claimed in claim 2 wherein the third cog assembly includes a third cog, with the third cog including a third hole which extends therethrough and is inserted through by the hub upon engagement therebetween, and with the third hole having a size such that the third cog has a structural contact with the hub.

4. The cogset as claimed in claim 3 wherein the third cog assembly includes a plurality of third cogs, with the plurality of third cogs of the third cog assembly engaged and being in contact with each other, with each third cog including a third hole which extends therethrough and is inserted through by the hub upon engagement therebetween, and with the third hole having a size such that the third cog has a structural contact with the hub and rotatable with the hub when the hub is rotated.

5. The cogset as claimed in claim 1 wherein the second cog assembly includes a plurality of groups of integrally made second cogs.

6. The cogset as claimed in claim 1 wherein the second cog assembly includes all the second cogs made integrally.

7. The cogset as claimed in claim 1 wherein each second cogs of the second cog assembly is formed separately.

8. The cogset as claimed in claim 1 wherein each first cog includes an outer peripheral edge including a plurality of teeth formed therearound, and with the plurality of teeth collectively defining a sinuate and enclosed cross section.

9. The cogset as claimed in claim 1 wherein each second cog includes an outer peripheral edge including a plurality of teeth formed therearound, and with the plurality of teeth collectively defining a sinuate and enclosed cross section.

10. The cogset as claimed in claim 3 wherein each third cog includes an outer peripheral edge including a plurality of teeth formed therearound, and with the plurality of teeth collectively defining a sinuate and enclosed cross section.

11. The cogset as claimed in claim 1 wherein the carrying member includes an inner peripheral edge delimiting the orifice, with the inner peripheral edge having a contour that conforms mutually to an outer peripheral edge of the hub such that the carrying member is prevented from rotating relative to the hub.

12. The cogset as claimed in claim 1 wherein the carrying member includes a plurality of lugs extending outwardly therefrom, and wherein the plurality of first cogs are connected to the carrying member by utilizing a plurality of fasteners to insert through the plurality of cogs and lugs.

13. The cogset as claimed in claim 1 wherein any two second cogs are connected with each other by engaging a plurality of ridges formed on one second cog in a plurality of recesses formed on the other.

14. The cogset as claimed in claim 12 wherein the plurality of ridges collectively define a contour conforming mutually to a contour the plurality of recesses collectively define such that the two connected second cogs are prevented from relative rotation therebetween.

15. The cogset as claimed in claim 12 wherein the plurality of recesses in the at least one second cog collectively receive and conform mutually to an outer peripheral edge of the carrying member such that the plurality of second cogs are prevented from rotating relative to the carrying member.

16. The cogset as claimed in claim 4 wherein any two third cogs are engaged with each other by engaging an inner peripheral edge of one third cog with an outer peripheral edge of the other.

17. The cogset as claimed in claim 4 wherein each third cog includes an inner peripheral edge having a contour conforming mutually to an outer peripheral edge of the hub such that the third cog is prevented from rotating relative to the hub.

18. The cogset as claimed in claim 1 wherein the first cog assembly includes a plurality of first cogs, and with each first cog having a size greater than a size of the connected hub 40 so each first cog is free of a structural contact with the hub.
